(19) United States
(12) Patent Application Publication
(10) Pub. No.: US 2024/0144767 A1
(43) Pub. Date: May 2, 2024

(54) KIOSK FOR RETURNING LICENSE PLATES AND OTHER ONLINE DMV SERVICES

(71) Applicant: William Eschert, Wilmington, NC (US)

(72) Inventor: William Eschert, Wilmington, NC (US)

(21) Appl. No.: 18/499,521

(22) Filed: Nov. 1, 2023

Related U.S. Application Data
(60) Provisional application No. 63/421,521, filed on Nov. 1, 2022.

(51) Int. Cl. G07F 7/00

(52) U.S. Cl. CPC G07F 7/00; G06Q 50/26

(57) ABSTRACT

A kiosk for returning license plates to the DMV. The kiosk comprises a mechanism for scanning the license plate, the identification of the user, a means for storing the license plates, a means for printing a receipt for the user, a means for the user to receive an electronic receipt, and a means for the DMV to electronically store and review the returned license plates.

### CROSS-REFERENCE TO RELATED APPLICATIONS

This application relates to provisional application U.S. 63/421,521 filed on Nov. 1, 2022 and is incorporated in its entirety.

### PRIOR ART

While various forms of kiosks are well known in the prior art such as US 2021/0065109, US 2019/0172041, U.S. Pat. Nos. 9,984,352, and 11,120,498, none relate to the governmental responsibility of collecting license plates after insurance on a vehicle has been cancelled. least one specification heading is required.

In many states when a vehicle owner cancels their car insurance the owner must return the license plate to the DMV to prove the owner is no longer operating the vehicle. DMV's experience large numbers of people coming in to drop of license plates but wind up waiting substantial periods of time for brief transactions.

None of the above inventions and patents, taken either singly or in combination, is seen to describe the invention as claimed. Thus, a need for a kiosk for returning license plates exists.

### BACKGROUND OF THE INVENTION

At least one specification heading is required. Please delete this heading section if it is not applicable to your application. For more information regarding the headings of the specification, please see MPEP 608.01(a).

### SUMMARY OF THE INVENTION

The present invention relates to returning old license plates after insurance on a vehicle has been cancelled.

The kiosk operates by inserting the license plate and a form of identification into the machine, the machine displays the plate on the screen and verifies the owner would like to return his or her license plates back to the DMV. Upon accepting, the kiosk prints a receipt indicating that the owner has returned his or her plates to the DMV. Additionally, the DMV also receives an electronic record of the receipt. The present subject matter will also offer access to the DMV's online services.

The present subject matter not only saves the owner wanting to return their license plate time, but it also saves time for the other people waiting in line for other unrelated matters. The present subject matter also saves the workers at the DMV time and resources.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF DRAWINGS

FIG. 1 is a front view of a kiosk for returning license plates according to an embodiment of the present subject matter.

### DETAILED DESCRIPTION OF THE INVENTION

The various embodiments of the present invention will hereinafter be described in conjunction with the appended drawings, wherein like designations denote like elements. least one specification heading is required.

The present invention is directed to a kiosk for returning license plates.

In one embodiment of the present subject matter, kiosk for returning license plates may comprise of an internal scanning mechanism to scan the license plate.

In one embodiment of the present subject matter, kiosk for returning license plates may comprise of an internal scanning mechanism to scan the driver's license or other form of identification of the person returning the license plate.

In one embodiment of the present subject matter, kiosk for returning license plates may comprise of an internal storage system for holding license plates for later removal by DMV workers.

In one embodiment of the present subject matter, kiosk for returning license plates may comprise of a display screen to confirm the user is certain he or she wants to return the license plate.

In one embodiment of the present subject matter, kiosk for returning license plates may comprise of a printer for printing out receipts to the user.

In one embodiment of the present subject matter, kiosk for returning license plates may comprise of an internal computer designed to send electronic receipts to the user should the user opt out of a physical receipt.

In one embodiment of the present subject matter, kiosk for returning license plates may comprise of an internal computer designed to electronically store a copy of each plate and associated identification for later reference by the DMV.

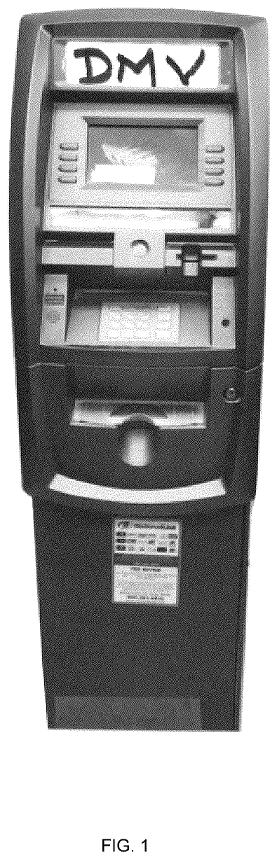

Referring now to the drawings, there is shown in FIG. 1 a front view of a kiosk for returning license plates. There is an entry point for the license plates. There is a location to scan the user's identification. There is a mechanism for printing receipts. There is a display screen for users to confirm that they would like to return their license plates. There is also internal storage for the license plates themselves. Furthermore, there is an internal computer system for emailing electronic receipts as well as data for later reference by the DMV.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

1. A kiosk for returning license plates to the DMV wherein the kiosk comprises of a mechanism to scan license plates, a mechanism to scan user identification, a mechanism to store the license plates, a mechanism to print of receipts, a display screen to confirm the user's intent to return the license plate, an internal computer to provide electronic receipts, an internal computer to provide a record for later review by the DMV, and ability to access the DMV's online services.
